(19) United States
(12) Patent Application Publication
(10) Pub. No.: US 2025/0197564 A1
(43) Pub. Date: Jun. 19, 2025

(54) METHOD FOR PRODUCING POLYOXYETHYLENE DERIVATIVE, METHOD FOR QUANTITATING POLYOXYETHYLENE COMPOUND, AND LABELING REAGENT FOR ANALYSIS USE

(71) Applicant: NOF CORPORATION, Tokyo (JP)

(72) Inventors: Ken HAMURA, Kawasaki-shi, Kanagawa (JP); Masaki KAMIYA, Kawasaki-shi, Kanagawa (JP)

(73) Assignee: NOF CORPORATION, Tokyo (JP)

(21) Appl. No.: 18/842,612

(22) PCT Filed: Mar. 6, 2023
(86) PCT No.: PCT/JP2023/008303

§ 371 Date: Aug. 29, 2024

(30) Foreign Application Priority Data
Mar. 9, 2022 (JP) 2022-035886

(51) Int. Cl. C08G 65/332; C08G 65/331; C08G 65/333; C08G 65/334; G01N 24/08

(52) U.S. Cl. CPC C08G 65/3322; C08G 65/3312; C08G 65/33337; C08G 65/3346; G01N 24/088

(57) ABSTRACT

A method for producing a high molecular weight polyoxyethylene derivative having a derivatized hydroxyl group is disclosed. The method includes labeling an unreacted high molecular weight polyoxyethylene compound having a hydroxy group using a labeling reagent in a deuterated solvent, and quantitating a labeled solution by a pre-saturation method and a proton nuclear magnetic resonance spectroscopy using inverse gated decoupling. The method allows a prompt quantitation of unreacted high molecular weight polyoxyethylene compound having a hydroxy group with a high accuracy.

### TECHNICAL FIELD

The present invention relates to a method for producing a polyoxyethylene derivative, a method for quantitating a polyoxyethylene compound, and a labeling reagent for analysis use.

### BACKGROUND ART

When a pharmaceutical that uses bio-related substances such as hormones, cytokines, and enzymes is administered into a general living body, it is promptly excreted from the living body through glomerular filtration in the kidneys and uptake by macrophages in the liver or spleen. Therefore, the half-life in the blood is short, and it is often difficult to obtain a sufficient pharmacological effect. In order to solve this problem, attempts have been made to chemically modify the bio-related substances with water-soluble polymers such as polyoxyethylene (PEG). As a result, it is possible to extend the half-life in the blood of the bio-related substances by increasing the molecular weight and forming a hydration layer. It is also well known that these modifications can produce effects such as reduction in toxicity and antigenicity of the bio-related substances, improvement in aggregation properties, and the like.

A structure of a PEG derivative generally has, at a polyoxyethylene end, an active group that chemically bonds to a functional group such as an amino group, a mercapto group, a carboxy group, or an unsaturated bond present on the surface of a protein to be modified. For example, the PEG end includes active groups such as a formyl group, an epoxy group, a p-nitrophenyl ester group, and a N-hydroxysuccinimidyl ester group in the case of modifying an amino group, active groups such as a mercapto group, a maleimidyl group, a substituted maleimidyl group, an allyl group, and a N-hydroxysuccinimidyl ester group in the case of modifying a mercapto group, active groups such as a mercapto group and an amino group in the case of modifying a carboxy group, and active groups such as a mercapto group in the case of modifying an unsaturated bond.

However, particularly in the case of modifying a low molecular weight drug or peptide, there is a problem that it is difficult to obtain effects such as improvement in solubility since there are few reactive functional groups to be bonded to the PEG derivative. In addition, in the case of modification with a large number of PEG derivatives, there is a problem that active sites of the drug or peptide is blocked, making it impossible for the drug or peptide to fully express the own functions and medicinal efficacy. Therefore, in recent years, PEG derivatives having a higher molecular weight have been used in order to efficiently obtain the effect even with the minimum number of modifications without reducing the function or medicinal efficacy of a physiologically active substance.

PEG derivatives having active groups (activated PEG derivatives) intended for these medical uses are required to have few impurities from the viewpoint of the performance and safety of drugs produced by modifying the PEG derivatives, and further, impurities produced as by-products during the production process and remaining raw materials and intermediates are required to be appropriately managed. For example, in the pharmaceutical industry where batch production is the mainstream, in some cases, tests are carried out at any process of the production to determine the amount of the remaining raw materials, the impurities produced as by-products, or the like, the process is temporarily put on standby during the test, and after finding that the test has passed, the process proceeds to the next process.

Currently, the activated PEG derivatives having various backbones such as linear and branched structures are being developed, and the amount of the impurities produced as by-products varies depending on a production method. The activated PEG derivatives are generally produced by using a hydroxy group-containing PEG compound (PEG-OH) as a raw material or intermediate through a derivatization process such as modification of the hydroxy group or bonding to an active group. Therefore, when the hydroxy group is insufficiently derivatized, the PEG-OH remains as a trace component in the PEG derivative having a derivatized hydroxy group obtained during the production process or in the activated PEG derivative as a final product.

In addition, the PEG-OH remaining as a trace component becomes an impurity other than the target compound in the production process of the activated PEG derivative, leading to a decrease in purity in some cases.

Therefore, there is a need for a production method that can highly sensitively quantitate and appropriately manage the amount of the unreacted PEG-OH remaining in trace amount in the PEG derivative after derivatization in a hydroxy group derivatization process.

In particular, as demand for a high molecular weight PEG derivative has increased in recent years, in the process of derivatizing the hydroxy group in the high molecular weight PEG-OH, a production method in which the amount of the high molecular weight PEG-OH remaining in trace amount in the high molecular weight PEG derivative after derivatization is quantitated with high sensitivity and appropriately managed is important for improving the purity of the high molecular weight PEG derivative.

Appropriate management here means that the amount of the high molecular weight PEG-OH remaining in trace amount in the derivatization process is quantitated with high sensitivity, it is found, based on analysis results, that quality characteristics such as an introduction rate of active groups into the high molecular weight PEG derivative after derivatization are not influenced, and a specified process such as a reaction or purification process is completed and is moved on to a next process, and means that appropriate measures such as extending of a reaction time or addition of a purification process are taken when the quality characteristics are influenced.

Further, in the case of appropriately managing the amount of the high molecular weight PEG-OH remaining in trace amount, it is necessary to promptly complete the specified process and move on to the next process from the viewpoint of product stability and productivity. Therefore, the highly sensitive quantitation method used is also required to have simplicity and promptness. For example, when it takes time to quantitate the high molecular weight PEG-OH, a specified process cannot be completed, resulting in an increase in production time and leading to product deterioration during the process in some cases.

Examples of a method for quantitating the PEG-OH include a titration method such as a neutralization titration method, a potentiometric titration method, and a pyridine-acetyl chloride method. However, these quantitation methods are generally analysis techniques when the PEG-OH is a main component. In addition, the greater an analytical error and the greater the molecular weight of an analytical sample, the greater the influence of the error. Therefore, it is not suitable as a highly sensitive method for quantitating a trace amount of an unreacted high molecular weight PEG-OH contained in the high molecular weight PEG derivative after derivatization.

In addition, a nuclear magnetic resonance spectroscopy (NMR method) is known as analysis means for highly sensitively quantitating a high molecular weight PEG-OH contained in a high molecular weight PEG derivative (see, for example, Patent Literature 1).

Examples of a simpler NMR method includes a method of labeling a PEG-OH in an aprotic deuterated solvent using an isocyanate reagent such as trichloroacetyl isocyanate as a labeling reagent, and then performing ¹H-NMR measurement (see, non-Patent Literature 1).

### PRIOR ARTS

### Non-Patent Literature

Non-Patent Literature 1: “A simple method for determining protic end-groups of synthetic polymers by ¹H NMR spectroscopy”, Almar Postma et. al., “Polymer” 47 (2006) pages 1899-1911

### Patent Literature

Patent Literature 1: JP4412461B

### SUMMARY OF INVENTION

### Problem to be Solved by the Invention

In Patent Literature 1, methanesulfonyl chloride is used as a labeling reagent, and it is possible to label an unreacted high molecular weight PEG-OH remaining in trace amount and to quantitate the same by ¹H-NMR analysis. However, the configuration of Patent Literature 1 requires a purification operation after labeling, and there is a problem that it lacks the simplicity and the promptness required for in-process management.

In addition, with the NMR method described in Non-Patent Literature 1, it is possible to quantitate the PEG-OH when it is a main component. However, in the case of quantitating an unreacted PEG-OH present as a trace component contained in a high molecular weight PEG derivative having derivatized a hydroxy group, the multiplet of a proton peak in a PEG chain becomes larger, causing an increase in noise and distortion of a baseline, and an S/N ratio of the peak derived from the labeled PEG-OH becomes small, increasing the measurement error, which cause a problem in quantitating property.

In this regard, as a method of increasing the S/N ratio of a target peak in the NMR method, generally, there is known a method of increasing a sample concentration or increasing the number of integrations during NMR measurement, or applying a pre-saturation method to huge peaks other than the target peak.

However, it is known that when the sample concentration of the high molecular weight PEG derivative is increased, the viscosity of a sample solution increases, the spectral width of the target peak increases, and the measurement error increases. In addition, the pre-saturation method is known to influence the peak intensity around the huge peak to which it is applied, and influences the quantitating property in some cases.

The present invention has been made in view of the above problems, and is to shorten a production time and enable appropriate management of a high molecular weight PEG-OH by simply, promptly, and highly sensitively quantitating an amount of an unreacted high molecular weight PEG-OH contained in a high molecular weight PEG derivative after derivatization in a process of derivatizing a hydroxy group in the high molecular weight PEG-OH.

### Means for Solving the Problem

As described above, in Patent Literature 1, since a proton peak derived from the labeling reagent overlaps the proton peak derived from the labeled high molecular weight PEG-OH, and peak separation is insufficient, a purification operation is required after labeling, and there is a problem that it lacks the promptness required for in-process management. In this regard, the method described in Non-Patent Literature 1 allows peak separation of the proton peaks derived from the labeling reagent and the labeled PEG-OH. However, as a method for quantitating the high molecular weight PEG-OH contained in the high molecular weight PEG derivative, there is a problem in quantitating property.

Further, there is a problem in quantitating the high molecular weight PEG-OH contained in trace amount in the high molecular weight PEG derivative using the ¹H-NMR method in the related art, and no method has been provided for producing a high molecular weight PEG derivative in which the amount of the unreacted high molecular weight PEG-OH in trace amount can be subjected to in-process management using the ¹H-NMR method.

As a result of intensive studies, the inventors of the present invention have found a method for producing a high molecular weight PEG derivative that can shorten the production time and a labeling reagent for a high molecular weight PEG-OH by using an analysis method that has both promptness and quantitating property and that allows the amount of the PEG-OH to be appropriately managed in a process of derivatizing a hydroxy group in which an unreacted high molecular weight PEG-OH remaining in trace amount in a high molecular weight PEG derivative having a derivatized hydroxy group is labeled using a labeling reagent in a deuterated solvent, and a labeled solution is promptly and highly sensitively quantitated using a pre-saturation method and a ¹H-NMR method using inverse gated decoupling.

That is, the present invention relates to the following (1) to (6).

(1) A method for producing a high molecular weight polyoxyethylene derivative having a derivatized hydroxy group by derivatizing a hydroxy group in a high molecular weight polyoxyethylene compound having the hydroxy group, the method including:
labeling the high molecular weight polyoxyethylene compound having the hydroxy group, which is unreacted, using a labeling reagent in a deuterated solvent; and
quantitating a labeled solution by a pre-saturation method and a proton nuclear magnetic resonance spectroscopy using inverse gated decoupling.

(2) The method according to (1), in which the high molecular weight polyoxyethylene compound having the hydroxy group is represented by the following formula (1).

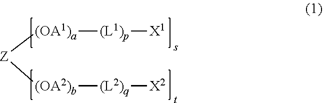

(In the formula (1),
OA¹ and OA² are an oxyethylene group,
a and b are each independently 0 to 2,500, and a+b is 200 or more,
L¹ and L² are each independently an alkylene group which may have a bond selected from an ester bond, a urethane bond, an amide bond, a urea bond, an ether bond, and a thioether bond in an alkylene chain or at an end thereof, and the alkylene groups may be same as or different from each other in one molecule,
p and q are each independently 0 or 1,
s and t are each independently 0 to 8, and 2≤s+t≤8,
X¹ is a hydroxy group, an alkoxy group, an azide group, an oxycarbonyl group, an oxycarbonyloxy group, an oxycarbamoyl group, a cyano group, a silyl group, an acyloxy group, a sulfonyl group, or an imido group, and when t is 0, X¹ is a hydroxy group,
X² is a hydroxy group, and
Z is a residue obtained by removing all hydroxy groups from a compound having 2 to 8 hydroxy groups and 2 to 21 carbon atoms.)

(3) The method according to (1) or (2), in which the high molecular weight polyoxyethylene derivative having a derivatized hydroxy group is represented by the following formula (2).

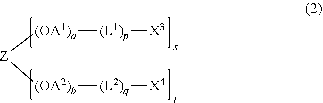

(In the formula (2),
OA¹ and OA² are an oxyethylene group,
a and b are each independently 0 to 2,500, and a+b is 200 or more,
L¹ and L² are each independently an alkylene group which may have a bond selected from an ester bond, a urethane bond, an amide bond, a urea bond, an ether bond, and a thioether bond in an alkylene chain or at an end thereof, and the alkylene groups may be same as or different from each other in one molecule,
p and q are each independently 0 or 1,
s and t are each independently 0 to 8, and 2≤s+t≤8,
X³ and X⁴ are each independently an alkoxy group, an azide group, an oxycarbonyl group, an oxycarbonyloxy group, an oxycarbamoyl group, a cyano group, a silyl group, an acyloxy group, a sulfonyl group, or an imido group, and
Z is a residue obtained by removing all hydroxy groups from a compound having 2 to 8 hydroxy groups and 2 to 21 carbon atoms.)

(4) The method according to any one of (1) to (3), in which the labeling reagent is an isocyanate reagent represented by the following formula (3).

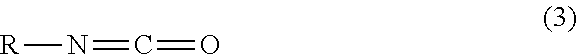

(In the formula (3), R represents an organic group having an electron-withdrawing group.)

(5) A labeling reagent for analysis use for a high molecular weight polyoxyethylene compound having a hydroxy group, which is represented by a formula (3).

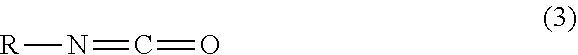

(In the formula (3), R represents an organic group having an electron-withdrawing group.)

(6) A method for quantitating a high molecular weight polyoxyethylene compound having a hydroxy group contained in a high molecular weight polyoxyethylene derivative, the method including:
labeling the high molecular weight polyoxyethylene compound having a hydroxy group using a labeling reagent in a deuterated solvent; and
quantitating a labeled solution by a pre-saturation method and a proton nuclear magnetic resonance spectroscopy using inverse gated decoupling.

### Effects of Invention

According to the present invention, in a process of derivatizing a high molecular weight PEG compound having a hydroxy group, when an amount of an unreacted high molecular weight PEG-OH remaining in trace amount is promptly and highly sensitively quantitated using a ¹H-NMR method, it is possible to appropriately manage the production process, shorten the production time, and provide a high molecular weight end-activated PEG derivative having a high purity.

### EMBODIMENTS FOR CARRYING OUT THE INVENTION

Hereinafter, a method for producing a high molecular weight polyoxyethylene derivative having a derivatized hydroxy group, a method for quantitating a high molecular weight polyoxyethylene compound having a hydroxy group, and a labeling reagent for analysis use for a high molecular weight polyoxyethylene compound having a hydroxy group according to the present invention will be described in detail.

A process of derivatizing a hydroxy group in a high molecular weight polyoxyethylene compound having a hydroxy group (may be abbreviated as a “high molecular weight PEG-OH” in the present description) (producing a high molecular weight polyoxyethylene derivative) refers to a series of production processes to obtain a target high molecular weight polyoxyethylene derivative after derivatization (may be abbreviated as a “high molecular weight PEG derivative” in the present description), which includes reaction processes including a multi-stage reaction by one-pot synthesis and a purification process, using a high molecular weight PEG-OH as a raw material. As long as the high molecular weight PEG-OH is used as a raw material, there is no restriction on the number of reaction stages in the one-pot synthesis, and two stages are preferred.

Examples of a reaction for derivatizing the hydroxy group in the high molecular weight PEG-OH include esterification, etherification, mesylation, cyanoethylation, and silylation. Specific examples of the one-pot synthesis include the following.
A two-stage reaction in which a hydroxy group is mesylated with methanesulfonyl chloride, and then sodium methoxide is spiked to the same reaction system to form a methoxy group.
A two-stage reaction in which a hydroxy group is replaced with a phthalimide group and then deprotected with hydrazine or the like to form an amino group.
A reaction in which a hydroxy group is reacted with a carboxylic anhydride under basic conditions, esterified to form a carboxylic acid form, and then N-hydroxysuccinimide is added to the same reaction system to introduce an active group.

In the present invention, in labeling an unreacted high molecular weight PEG-OH in a high molecular weight PEG derivative, there are no particular restriction on a deuterated solvent to be used as long as it is an aprotic deuterated solvent. Examples thereof include deuterated dimethyl sulfoxide, deuterated dimethylformamide, deuterated dichloromethane, deuterated acetone, deuterated chloroform, deuterated acetonitrile, deuterated tetrahydrofuran, and deuterated benzene, and preferably, deuterated dimethyl sulfoxide, deuterated dimethylformamide, deuterated dichloromethane, deuterated acetone, deuterated chloroform, and deuterated acetonitrile. More preferably, deuterated dimethyl sulfoxide, deuterated dichloromethane, and deuterated chloroform, and still more preferably deuterated chloroform.

In the present invention, it is necessary to define a reference peak in a proton nuclear magnetic resonance spectroscopy (hereinafter may be abbreviated as a ¹H-NMR method). Examples of the reference peak include a solvent peak contained in a deuterated solvent and a peak derived from tetramethylsilane or hexamethyldisiloxane spiked as a reference substance, and is preferably a peak derived from tetramethylsilane or hexamethyldisiloxane, and more preferably a peak derived from tetramethylsilane.

In the present invention, the pre-saturation method is applied to a PEG chain-derived proton peak in the ¹H-NMR method. A chemical shift thereof varies depending on the deuterated solvent, and is 3.56 ppm, for example, when deuterated chloroform is used as the deuterated solvent.

In addition, in the pre-saturation method, the signal intensity of the maximum peak can be reduced by emitting radio waves having a specific frequency in advance, and the signal intensity of the maximum peak can be controlled based on the output of the radio waves. However, when the output of the radio waves is too large, the signal intensity of a peak around the maximum peak is small, and when it is too small, an S/N ratio of a target peak cannot be improved. Therefore, it is necessary to control the output of the radio waves as an attenuation amount using an attenuator of a nuclear magnetic resonance apparatus. The attenuation amount is preferably 40 dB to 90 dB, more preferably 50 dB to 80 dB, and still more preferably 60 dB to 70 dB.

In the present invention, an amount of the high molecular weight PEG-OH in the high molecular weight PEG derivative can be calculated based on an integral value of a peak (hereinafter may be abbreviated as a “target product-derived peak”) derived from a methylene group next to an oxygen atom in a urethane bond of a compound after the high molecular weight PEG-OH is labeled by an isocyanate reagent as a labeling reagent (to be described later), using an integral value of a peak detected at a predetermined chemical shift as a reference (hereinafter may be abbreviated as a “quantitation reference peak”).

Further, in quantitating the amount of the high molecular weight PEG-OH, it is necessary to set a quantitation reference peak. This quantitation reference peak may be detected within a range where the influence of the pre-saturation method is small and at a chemical shift that does not overlap a chemical shift of the target product-derived peak, and is preferably detected at a frequency that is 0.5 ppm or more away, and more preferably 0.9 ppm or more away from a chemical shift value of the proton derived from the PEG chain. As preferred aspects of the quantitation reference peak, for example, an integral value of a peak derived from tetramethylsilane as a reference peak, or an integral value of a peak derived from a high molecular weight PEG derivative may be used as the quantitation reference peak, and a quantitation reference substance such as triphenylmethane may be spiked, and an integral value of a peak derived from the quantitation reference substance may be used as the quantitation reference peak. Preferably, it is a peak derived from a high molecular weight PEG derivative or a peak derived from a quantitation reference substance.

In the ¹H-NMR method, it is known that peaks coupled with ¹³C, which has a low natural abundance, are detected as satellite signals on both sides of a main signal. For example, 1.1% of ¹H bonded to adjacent carbon atoms is split due to spin coupling with ¹³C contained in 1.1%, satellite signals with a height of 0.55% are detected on both sides of the main signal, and an integral value of a target product peak is smaller, which influences the quantitating property. In quantitation using the ¹H-NMR method, in order to eliminate the influence of the satellite signals on the quantitating property, an inverse gated decoupling method that does not cause signal splitting due to coupling with ¹³C is used.

The process of quantitating the unreacted high molecular weight PEG-OH using a ¹H-NMR method is performed during a reaction process including a multi-stage reaction by one-pot synthesis or during a purification process, and preferably during a reaction process.

It is preferable that a lower limit value of quantitating the unreacted high molecular weight PEG-OH using a ¹H-NMR method is as small as possible, and according to the present invention, as will be described later, it is possible to quantitate up to 0.2 wt %.

In a preferred embodiment, the high molecular weight PEG-OH is represented by the following formula (1).

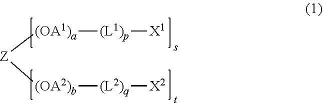

Hereinafter, groups in the formula (1) will be described in detail.

In the formula (1), OA¹ and OA² are a divalent oxyethylene group represented by the following formula (4), * represents a bonding position with Z, ** represents a bonding position with L¹ or L², and n in the formula (4) is the number of moles of the oxyethylene group added and is a or b to be described later.

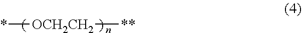

a and b are each independently 0 to 2,500, and a+b is 200 or more, a and b each preferably 0 to 1,100. In addition, a+b is 200 or more, preferably 200 to 3,500, and more preferably 200 to 2,500.

Note that, the “high molecular weight” of the “high molecular weight PEG-OH” and the “high molecular weight PEG derivative” means that the total number of moles of the oxyethylene group added constituting each polyoxyethylene moiety is 200 or more. That is, the molecular weight of the “high molecular weight PEG-OH” and the “high molecular weight PEG derivative” in the present invention is a number average molecular weight determined by size exclusion chromatography, mass spectrometry, or the like, and is preferably 8,800 or more and 220,000 or less.

L¹ and L² are each independently an alkylene group which may have a bond selected from an ester bond, a urethane bond, an amide bond, a urea bond, an ether bond, and a thioether bond in an alkylene chain or at an end thereof, and the alkylene groups may be same as or different from each other in one molecule. L′ and L² are each preferably an alkylene group which may have a bond selected from an ester bond, an amide bond, an ether bond, a thioether bond, a urethane bond, and a urea bond in the alkylene chain or at the end thereof, and more preferably an alkylene group which may have a bond selected from an ester bond, an amide bond, an ether bond, and a urethane bond in the alkylene chain or at the end thereof. A particularly preferred form is one or more divalent spacers selected from the group consisting of formulas (z1), (z2), (z3), (z4), (z5), (z6), (z7), (z8), (z9), and (z10) shown in the following group (I). Preferably, 2 or more and 5 or less divalent spacers selected from the group consisting of formulas (z1), (z2), (z3), (z4), (z5), (z6), (z7), (z8), (z9), and (z10) shown in the following group (I) may be combined.

### Group (I)

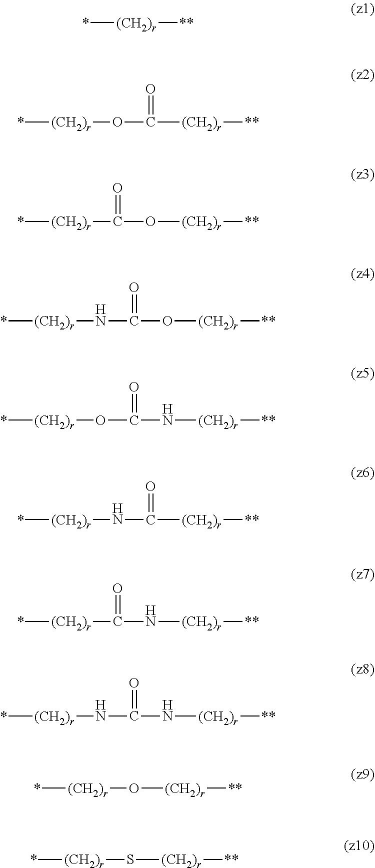

In the formulas (z1), (z2), (z3), (z4), (z5), (z6), (z7), (z8), (z9), and (z10) shown in the group (I), “*” represents a bonding position with OA¹ or OA², and “**” represents a bonding position with X¹ or X².

In the formula (z1), r represents an integer of 1 to 10, preferably an integer of 1 to 6, and more preferably an integer of 1 to 5.

In the formula (z2) to the formula (z10), r's each independently represent an integer of 0 to 10, preferably an integer of 0 to 6, and more preferably an integer of 0 to 5. In addition, in the formula (z2) to the formula (z10), r's may be same as or different from each other.

In the formula (1), p and q respectively represent a repeating unit of L¹ and L² respectively bonded to X¹ or X², and are each independently 0 or 1, a single bond is obtained in the case where p and q are 0, and when X¹ and X² are hydroxy groups, p and q are preferably 0.
s and t are each independently 0 to 8, and 2≤s+t≤8.
X¹ is a hydroxy group, an alkoxy group, an azide group, an oxycarbonyl group, an oxycarbonyloxy group, an oxycarbamoyl group, a cyano group, a silyl group, an acyloxy group, a sulfonyl group, or an imido group, and when t is 0, X¹ is a hydroxy group.
X² is a hydroxy group.

The hydroxy group in the definition of X¹ and X² in the formula (1) is a monovalent functional group represented by (—OH).

The alkoxy group in the definition of X¹ in the formula (1) is a monovalent functional group represented by (—OR¹). R¹ is an optionally substituted hydrocarbon group, and is preferably an alkyl group such as a methyl group, an ethyl group, a propyl group, an isopropyl group, a benzyl group, a trityl group, or an allyl group.

The number of carbon atoms in R¹ is preferably 1 to 30, and more preferably 1 to 20.

The azide group in the definition of X¹ in the formula (1) is a monovalent functional group represented by (—N₃).

The oxycarbonyl group in the definition of X¹ in the formula (1) is a monovalent functional group represented by (—COOR²), and R² is an optionally substituted hydrocarbon group or a group represented by the following formulas (r1) to (r3). Examples of the optionally substituted hydrocarbon group include a linear or branched hydrocarbon group having 1 to 6 carbon atoms, a pentafluorophenyl group, and a p-nitriphenyl group, and R² is preferably an alkyl group such as a methyl group, an ethyl group, a propyl group, a butyl group, an isopropyl group, an isobutyl group, or a tert-butyl group, a benzyl group, a pentafluorophenyl group, a p-nitriphenyl group, or the formula (r1).

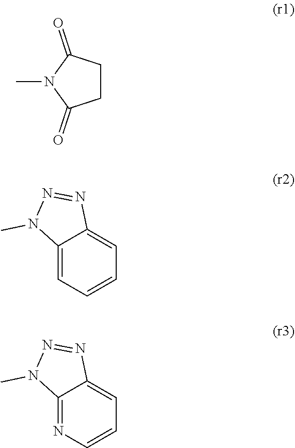

The oxycarbonyloxy group in the definition of X¹ in the formula (1) is a monovalent functional group represented by (—OCOOR³), and R³ is a hydrocarbon group or a group represented by the following formulas (r1) and (r4). The number of carbon atoms in R³ is preferably 1 to 10, and more preferably 1 to 6. R³ is preferably an alkyl group such as a methyl group, an ethyl group, or a propyl group, or a group represented by the formula (r1) or the formula (r4), more preferably a group represented by the formula (r1) or the formula (r4), and still more preferably the formula (r1).

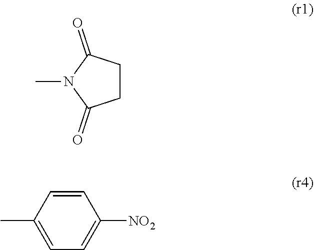

The oxycarbamoyl group in the definition of X¹ in the formula (1) is a monovalent functional group represented by (—NHCOOR⁴), and R⁴ is an optionally substituted hydrocarbon group. The number of carbon atoms in R⁴ is preferably 1 to 20, and more preferably 1 to 14. R⁴ is preferably an alkyl group such as a methyl group, an ethyl group, a propyl group, a butyl group, an isopropyl group, an isobutyl group, and a tert-butyl group, a benzyl group, an allyl group, a 2,2,2-trichloroethyl group, a 2-(trimethylsilyl) ethyl group, or a 9-fluorenylmethyl group, and more preferably a methyl group, a tert-butyl group, a benzyl group, an allyl group, a 2,2,2-trichloroethyl group, a 2-(trimethylsilyl) ethyl group, or a 9-fluorenylmethyl group.

The cyano group in the definition of X¹ in the formula (1) is a monovalent functional group represented by (—CN).

The silyl group in the definition of X¹ in the formula (1) is a monovalent functional group represented by (—Si(R⁵R⁶R⁷)). R⁵ to R⁷ are hydrocarbon groups and may be same as or different from each other, and the number of carbon atoms in R⁵ to R⁷ is preferably 1 to 10, and more preferably 1 to 7. Examples thereof include an alkyl group such as a methyl group, an ethyl group, a propyl group, a butyl group, a dodecyl group, an octyl group, an isopropyl group, and a tert-butyl group, a phenyl group, or a benzyl group, and preferred aspects of the silyl group are groups represented by the following formulas (r5) to (r9).

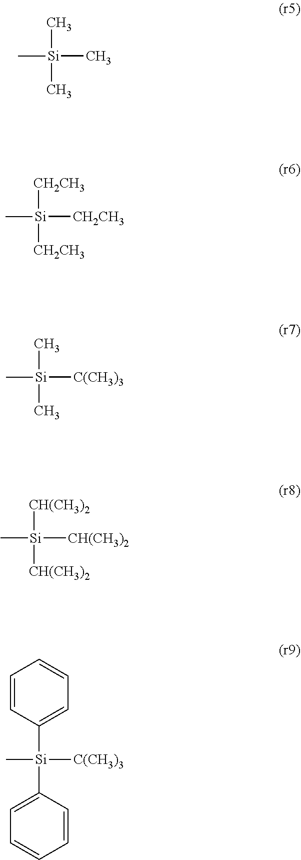

The acyloxy group in the definition of X¹ in the formula (1) is a monovalent functional group represented by (—OCOR⁸), and R⁸ is an optionally substituted hydrocarbon group. The number of carbon atoms in R⁸ is preferably 1 to 10, and more preferably 1 to 6. Preferred is an alkyl group such as a methyl group, an ethyl group, a propyl group, a butyl group, an isopropyl group, an isobutyl group, and a tert-butyl group, a phenyl group, a trifluoromethyl group, or a trichloromethyl group.

The sulfonyl group in the definition of X¹ in the formula (1) is a monovalent functional group represented by (—S(═O)₂R⁹), and R⁹ is a methyl group, a vinyl group, a trifluoromethyl group, a phenyl group, a p-methylphenyl group, an o-nitrophenyl group, a p-nitrophenyl group, a 2,4,6-trimethylphenyl group, a 2,4,6-triisopropylphenyl group, a pentafluorophenyl group, or a chloromethyl group, preferably a methyl group, a vinyl group, a trifluoromethyl group, or a p-methylphenyl group, and more preferably a methyl group or a vinyl group.

The imido group in the definition of X¹ in the formula (1) is a group represented by the following formulas (r10), (r11), and (r12), and preferably the formula (r10).

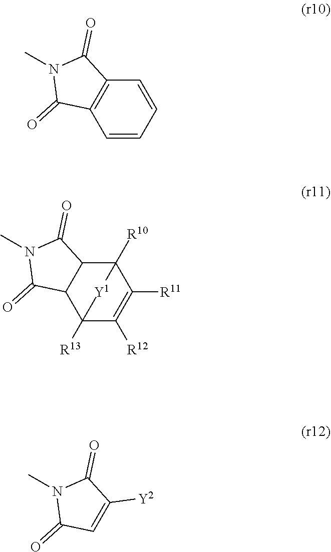

In the formula (r11), R¹⁰, R¹¹, R¹², and R¹³ are each independently a hydrogen atom or a hydrocarbon group having 1 to 5 carbon atoms. It is preferable that R¹⁰, R¹¹, R¹², and R¹³ are hydrogen atoms, R¹¹, R¹², and R¹³ are hydrogen atoms and R¹⁰ is a methyl group, R¹⁰, R¹¹, and R¹² are hydrogen atoms and R¹³ is a methyl group, or R¹¹ and R¹² are hydrogen atoms and R¹⁰ and R¹³ are methyl groups.

Y¹ in the formula (r11) is an ether group, a methylene group, or a dimethylvinylidene group, and among these, an ether group (that is, an oxygen atom) is preferred.

Y² in the formula (r12) is a hydrogen atom or a hydrocarbon group having 1 to 5 carbon atoms, and preferably a hydrogen atom or a hydrocarbon group having 1 to 5 carbon atoms. Examples of the hydrocarbon group having 1 to 5 carbon atoms include a methyl group, an ethyl group, a propyl group, an isopropyl group, a butyl group, or a tert-butyl group. A hydrogen atom, a methyl group, or an ethyl group is preferred, and a hydrogen atom is more preferred.

The compound having 2 to 8 hydroxy groups and 2 to 21 carbon atoms in the definition of Z in the formula (1) is written as Z(OH)ₛ₊ₜ. The residue Z is a residue obtained by removing all the (s+t) hydroxy groups from the compound Z(OH)ₛ₊ₜ.

The residue Z is preferably a hydrocarbon group that may have a nitrogen atom and/or an oxygen atom, and more preferably a saturated hydrocarbon group that may have a nitrogen atom and/or an oxygen atom. The number of carbon atoms in the hydrocarbon group is preferably 2 to 18, and more preferably 2 to 16. Specifically, the following forms can be exemplified.
A saturated hydrocarbon group consisting of carbon atoms and hydrogen atoms and having 2 to 21 carbon atoms.
A saturated hydrocarbon group consisting of carbon atoms, hydrogen atoms, and oxygen atoms and having 2 to 21 carbon atoms. Two saturated hydrocarbon groups are ether-bonded via respective oxygen atoms.
A saturated hydrocarbon group consisting of carbon atoms, hydrogen atoms, and nitrogen atoms and having 2 to 21 carbon atoms. Three saturated hydrocarbon groups are N—C-bonded to each other via respective nitrogen atoms.
A saturated hydrocarbon group consisting of carbon atoms, hydrogen atoms, oxygen atoms, and nitrogen atoms and having 2 to 21 carbon atoms. Two saturated hydrocarbon groups are ether-bonded to each other via respective oxygen atoms, and three saturated hydrocarbon groups are N—C-bonded to each other via respective nitrogen atoms.

In a preferred embodiment, the residue Z includes, for example, residues represented by formulas (z11) to (z20) described in a group (II).

### Group (II)

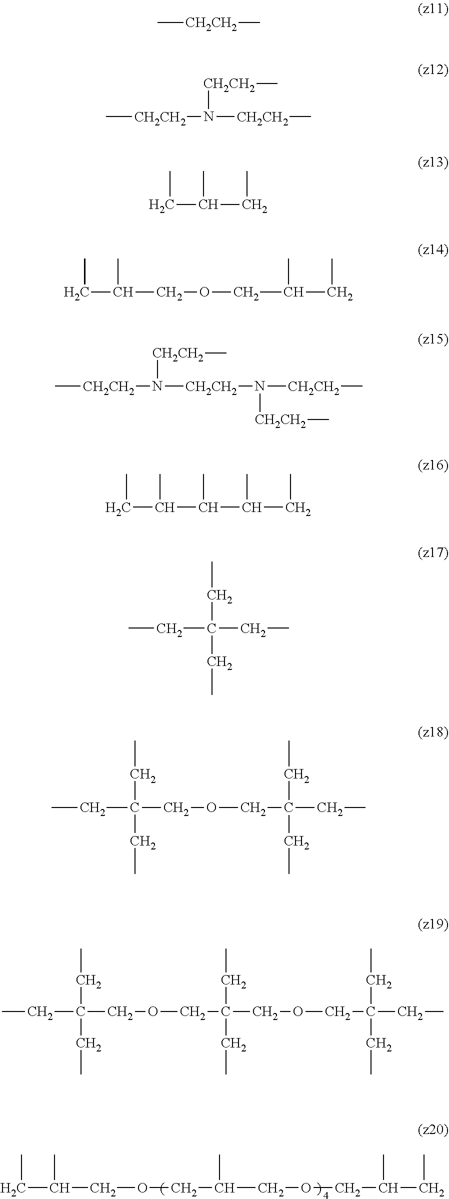

In the present invention, a preferred aspect is the formula (z11), the formula (z13), the formula (z16), the formula (z17), or the formula (z20), and a more preferred aspect is the formula (z11), the formula (z13), or the formula (z17).

In the following formula (4), which is one of the preferred aspects of the high molecular weight PEG-OH represented by the formula (1), Z in the formula (1) is the formula (z11).

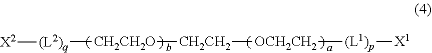

(In the formula (4), a, b, L¹, L², p, q, s, t, X¹, and X² have the same meanings as above.)

In the following formula (5), which is one of the preferred aspects of the high molecular weight PEG-OH represented by the formula (1), Z in the formula (1) is the formula (z13).

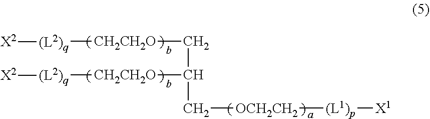

(In the formula (5), a, b, L¹, L², p, q, s, t, X¹, and X² have the same meanings as above.)

In the following formula (6), which is one of the preferred aspects of the high molecular weight PEG-OH represented by the formula (1), Z in the formula (1) is the formula (z16).

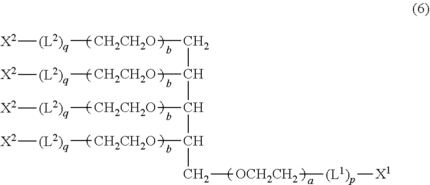

(In the formula (6), a, b, L¹, L², p, q, s, t, X¹, and X² have the same meanings as above.)

In the following formula (7), which is one of the preferred aspects of the high molecular weight PEG-OH represented by the formula (1), Z in the formula (1) is the formula (z17).

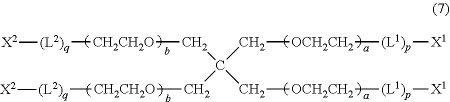

(In the formula (7), a, b, L¹, L², p, q, s, t, X¹, and X² have the same meanings as above.)

In the following formula (8), which is one of the preferred aspects of the high molecular weight PEG-OH represented by the formula (1), Z in the formula (1) is the formula (z20).

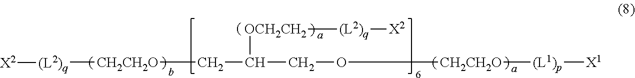

(In the formula (8), a, b, L¹, L², p, q, s, t, X¹, and X² have the same meanings as above.)

The high molecular weight polyoxyethylene derivative after derivatization according to the present invention is represented by the following formula (2).

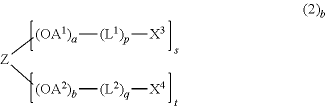

(In the formula (2),
OA¹ and OA² are an oxyethylene group,
a and b are each independently 0 to 2,500, and a+b is 200 or more,
L¹ and L² are each independently an alkylene group which may have a bond selected from an ester bond, a urethane bond, an amide bond, a urea bond, an ether bond, and a thioether bond in an alkylene chain or at an end thereof, and the alkylene groups may be same as or different from each other in one molecule,
p and q are each independently 0 or 1,
s and t are each independently 0 to 8, and 2≤s+t≤8,
X³ and X⁴ are each independently an alkoxy group, an azide group, an oxycarbonyl group, an oxycarbonyloxy group, an oxycarbamoyl group, a cyano group, a silyl group, an acyloxy group, a sulfonyl group, or an imido group, and
Z is a residue obtained by removing all hydroxy groups from a compound having 2 to 8 hydroxy groups and 2 to 21 carbon atoms.)

The explanations (specifically a, b, L¹, L², p, q, s, t, and Z) in the high molecular weight polyoxyethylene derivative according to the present invention represented by formula (2) are as described above, and X³ and X⁴ have the same meaning as X¹ in the high molecular weight polyoxyethylene compound having a hydroxy group according to the present invention represented by the formula (1).

The labeling reagent used in the present invention is represented by the following formula (3).

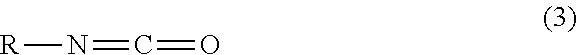

R in the formula (3) is an organic group having an electron-withdrawing group, and the electricity-withdrawing group is a substituent that tends to attract electrons from the bonded atom side compared to a hydrogen atom, and examples thereof include organic groups represented by formulas (r13) to (r49) described in a group (III).

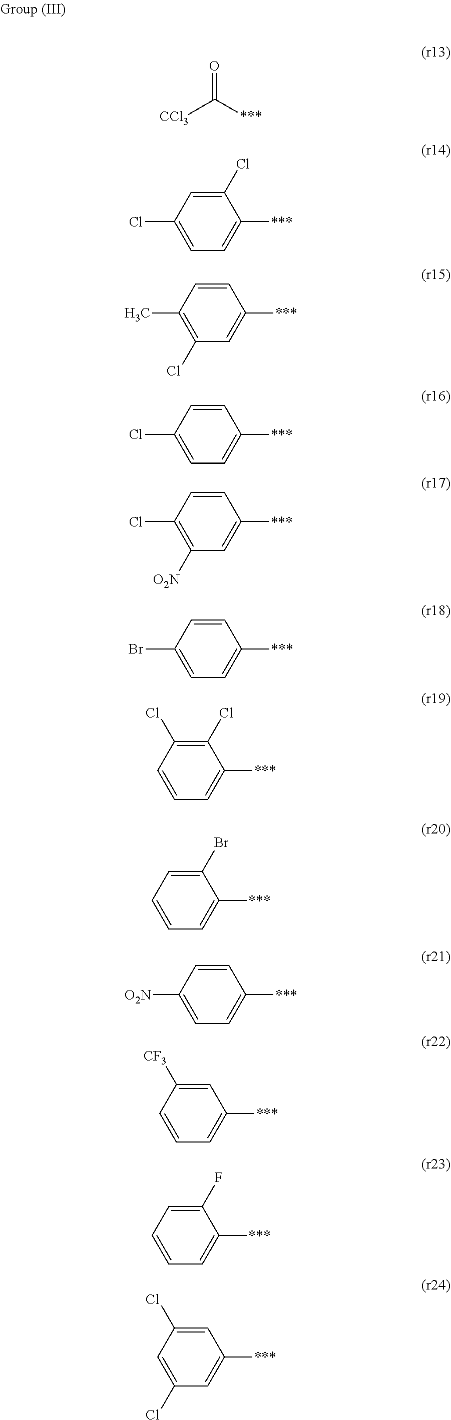

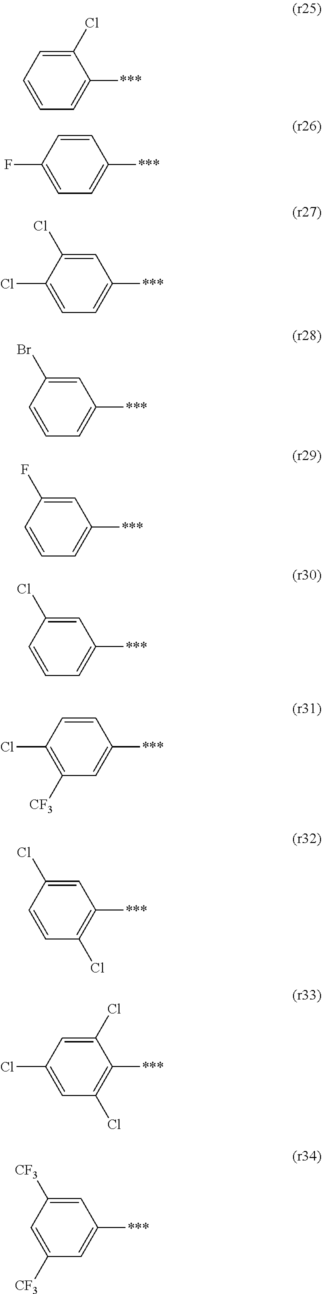

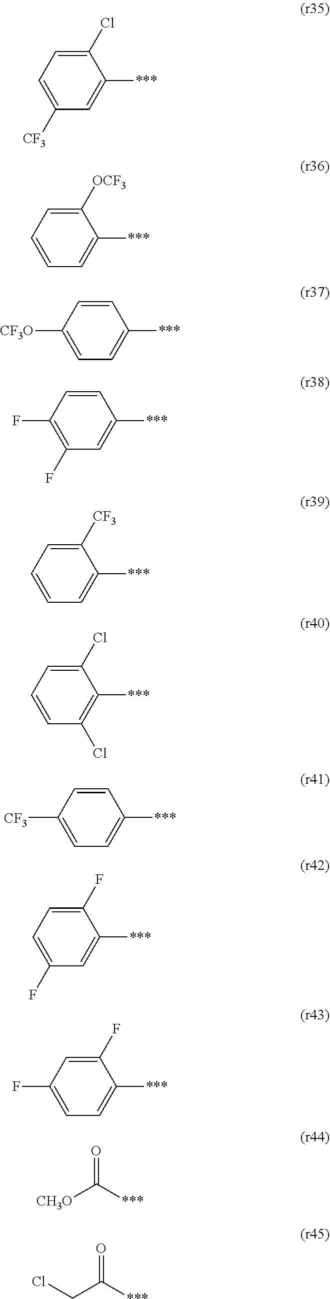

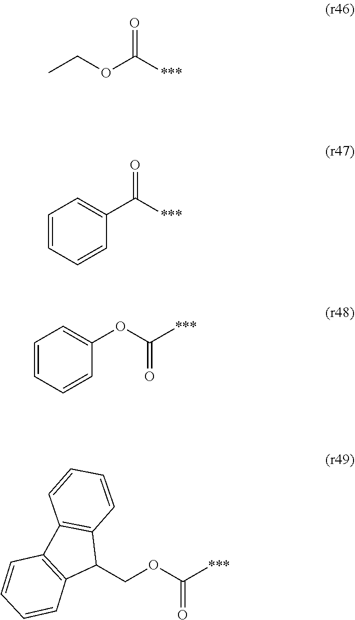

A particularly preferred aspect is the formula (r13), (r14), (r17), (r19), (r24), (r27), (r31), (r33), (r34), (r35), (r38), (r40), (r42), (r43), (r44), (r45), (r46), (r47), (r48), or (r49), a more preferred form is the formula (r13), (r23), (r44), (r45), (r46), (r47), (r48), or (r49), and a still more preferred form is the formula (r13). In addition, “***” represents a bonding position of —(N═C═O) with a nitrogen atom.

In the present invention, there is no particular restriction on the amount of the labeling reagent represented by the formula (3) used, as long as it is used in excess such that the unreacted high molecular weight polyoxyethylene compound having a hydroxy group can be sufficiently labeled. It is preferably used in an amount of 1 to 100 equivalents, more preferably 10 to 100 equivalents, and still more preferably 30 to 100 equivalents, with respect to the high molecular weight polyoxyethylene compound contained in the deuterated solvent.

In the present invention, the labeling reagent for analysis use for a high molecular weight polyoxyethylene compound is represented by the formula (3), and the explanation of the formula (3) is as described above. The labeling reagent for analysis use is not limited to ¹H-NMR analysis, but may be used for other analyses such as high performance liquid chromatography analysis.

### EXAMPLES

The present invention will be described in more detail with reference to Examples. The accuracy of quantitating the amount of the high molecular weight PEG-OH contained in a high molecular weight PEG derivative is shown, and note that the present invention is not limited to the following Examples.

¹H-NMR was obtained from a nuclear magnetic resonance apparatus (JNM-ECZ400 or JNM-ECA600) manufactured by JEOL Ltd. A tube having a diameter of 5 mm was used for the measurement, and CDCl₃ containing tetramethylsilane (TMS) was used as an internal standard substance for a deuterated solvent.

### Example 1: Evaluation on Quantitating Property of PEG-OH Contained in PEG Carboxylic Acid

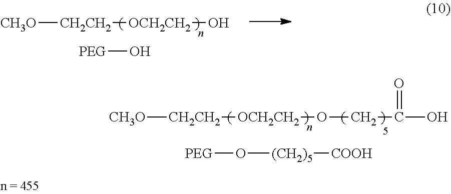

In an etherification reaction of obtaining PEG-O—(CH₂)₅—COOH (molecular weight: 20,000) from PEG-OH (molecular weight: 20,000), as represented by the formula (10), the quantitating property of the unreacted PEG-OH (molecular weight: 20,000) was checked by a spike and recovery test in the following manner.

That is, into a screw tube into which 100 mg of “SUNBRIGHT ME-200HC” (number average molecular weight: 20,185) manufactured by NOF Corporation having the same structure as the PEG-O—(CH₂)₅—COOH in the formula (10) was charged, “MEH-20T” (number average molecular weight: 19,689) manufactured by NOF Corporation having the same structure as the PEG-OH in the formula (10) was spiked at 0.1 wt % to 1.0 wt % with respect to “SUNBRIGHT ME-200HC” manufactured by NOF Corporation, to obtain each sample in Experiment 1 to Experiment 4. To each sample, 80 μL of triphenylmethane (10 μg/μL) dissolved in deuterated chloroform and 620 μL of deuterated chloroform were added, followed by dissolution. Thereafter, 20 μL of trichloroacetyl isocyanate (TCI product) was added to each sample, followed by mixing by inversion. After the mixing by inversion, each sample was measured using a nuclear magnetic resonance apparatus by applying a pre-saturation method to a PEG chain-derived proton peak (3.56 ppm) and using inverse gated decoupling under the following conditions.
Reference peak: TMS
Quantitation reference peak: triphenylmethane ((C₆H₅)₃—CH, 5.55 ppm)
Target product peak: —(OCH₂CH₂)ₙ—OCH₂CH₂—OCONH—COCCl₃, 4.42 ppm
Pulse sequence: single_pulse_irrdec
Attenuator: 60 dB
Measurement temperature: 25° C.
Number of times for integration: 1024

When the integral value of the quantitation reference peak was set to 0.6548, a spike and recovery rate of each sample was calculated according to the following equation.

Spike and recovery rate (%)=(integral value of target product peak/2)×100

An allowable range of the spike and recovery rate was set as ±30%, and a range in which the spike and recovery was possible was checked.

TABLE 1

| | Experiment | Experiment | Experiment | Experiment |
|---|---|---|---|---|
| | 1 | 2 | 3 | 4 |
| Spiked amount | 0.1 | 0.2 | 0.4 | 1.0 |
| (wt %) | | | | |
| Spike and | —(*) | 67.5 | 121.3 | 93.5 |
| recovery | | | | |
| rate (%) | | | | |

(*)not calculated due to no peak detected

As listed in Table 1, it is found that the PEG-OH contained in the PEG-O—(CH₂)₅—COOH in the formula (10) can be spiked and recovered in a range of at least 0.4 wt % or more, that is, it can be quantitated down to 0.4 wt %, with respect to the PEG-O—(CH₂)₅—COOH.

### Example 2: Evaluation on Quantitating Property of (PEG)₂-OH Contained in (PEG)₂-Phthalimide

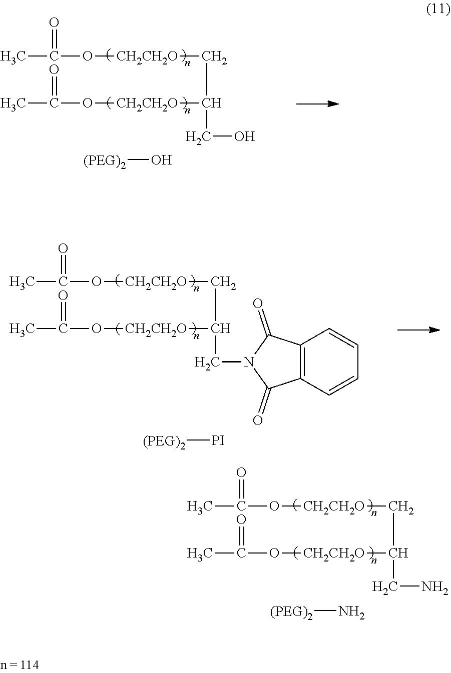

During one-pot synthesis as a two-stage reaction of obtaining (PEG)₂—NH₂ (molecular weight: 10,000) from (PEG)₂-OH (molecular weight: 10,000), as represented by the formula (11), in the first stage of phthalimidation reaction of obtaining (PEG)₂-PI from the (PEG)₂-OH, the quantitating property of the unreacted (PEG)₂-OH (molecular weight: 10,000) was checked by a spike and recovery test in the following manner.

Into a screw tube into which 100 mg of “SUNBRIGHT 2AC-GL2-100EI” (number average molecular weight: 10,082) manufactured by NOF Corporation having the same structure as the (PEG)₂-PI in the formula (11) was charged, “SUNBRIGHT 2AC-GL2-100HO” (number average molecular weight: 9,975) manufactured by NOF Corporation having the same structure as the (PEG)₂-OH in the formula (11) was spiked at 0.25 wt % to 0.50 wt % with respect to “SUNBRIGHT 2AC-GL2-100EI”, to obtain each sample in Experiment 5 and Experiment 6. To each sample, 80 μL of triphenylmethane (10 μg/μL) dissolved in deuterated chloroform and 620 μL of deuterated chloroform were added, followed by dissolution. Thereafter, 20 μL of trichloroacetyl isocyanate (TCI product) was added to each sample, followed by mixing by inversion. After the mixing by inversion, each sample was measured using a nuclear magnetic resonance apparatus by applying a pre-saturation method to a PEG chain-derived proton peak (3.56 ppm) and using inverse gated decoupling under the following conditions.
Reference peak: TMS
Quantitation reference peak: triphenylmethane ((C₆H₅)₃—CH, 5.55 ppm)
Target product peak: —CH((—OCH₂CH₂)ₙ—OCOCH₃)—CH₂—OCONH—COCCl₃, 4.34 ppm
Pulse sequence: single_pulse_irrdec
Attenuator: 50 dB
Measurement temperature: 25° C.
Number of times for integration: 256

When the integral value of the quantitation reference peak was set to 0.3274, a spike and recovery rate of each sample was calculated according to the following equation.

Spike and recovery rate (%)=(integral value of target product peak/1)×100

An allowable range of the spike and recovery rate was set as ±30%, and a range in which the spike and recovery was possible was checked.

TABLE 2

| | Experiment 5 | Experiment 6 |
|---|---|---|
| Spiked amount | 0.25 | 0.50 |
| (wt %) | | |
| Spike and recovery | 100 | 97.0 |
| rate (%) | | |

As listed in Table 2, it is found that the (PEG)₂-OH contained in the (PEG)₂-PI can be spiked and recovered in a range of 0.25 wt % or more, that is, it can be quantitated down to 0.25 wt %, with respect to the (PEG)₂-PI.

### Example 3: Evaluation on Quantitating Property of PEG-OH Contained in PEG-O—CH₂—C₆H₅

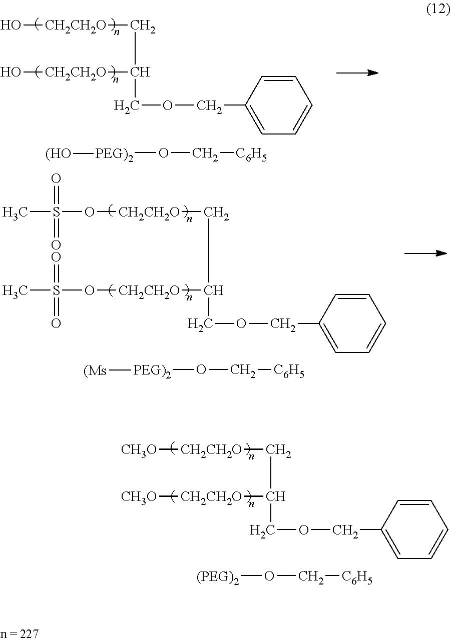

During one-pot synthesis as a two-stage reaction of obtaining (PEG)₂-O—CH₂—C₆H₅ from (HO-PEG)₂-O—CH₂—C₆H₅, as represented by the formula (12), in the second stage of methoxylation reaction of obtaining the (PEG)₂-O—CH₂—C₆H₅ from (Ms-PEG)₂-O—CH₂—C₆H₅, the quantitating property of the unreacted (HO-PEG)₂-O—CH₂—C₆H₅ was checked by a spike and recovery test in the following manner.

Into a screw tube into which 100 mg of “SUNBRIGHT GL2-200BZ” (number average molecular weight: 19,451) manufactured by NOF Corporation having the same structure as the (PEG)₂-O—CH₂—C₆H₅ in the formula (12) was charged, “SUNBRIGHT GL2-200BH” (number average molecular weight: 19,859) manufactured by NOF Corporation having the same structure as the (HO-PEG)₂-O—CH₂—C₆H₅ in the formula (12) was spiked at 0.1 wt % to 1.0 wt % with respect to “SUNBRIGHT GL2-200BZ”, to obtain each sample in Experiment 7 to Experiment 10. To each sample, 700 μL of deuterated chloroform was added, followed by dissolution. Thereafter, 20 μL of trichloroacetyl isocyanate (TCI product) was added to each sample, followed by mixing by inversion. After the mixing by inversion, each sample was measured using a nuclear magnetic resonance apparatus by applying a pre-saturation method to a PEG chain-derived proton peak (3.56 ppm) and using inverse gated decoupling under the following conditions.
Reference peak: TMS
Quantitation reference peak: —CH₂—O—CH₂—C₆H₅, 4.54 ppm
Target product peak: —((OCH₂CH₂)ₙ—OCH₂CH₂—OCONH—COCCl₃)₂, 4.42 ppm
Pulse sequence: single_pulse_irrdec
Attenuator: 60 dB
Measurement temperature: 25° C.
Number of times for integration: 1024

When the integral value of the quantitation reference peak was set to 2.000, a spike and recovery rate of each sample was calculated according to the following equation.

Spike and recovery rate (%)=(integral value of target product peak/4)×100

An allowable range of the spike and recovery rate was set as ±30%, and a range in which the spike and recovery was possible was checked.

TABLE 3

| | Experiment | Experiment | Experiment | Experiment |
|---|---|---|---|---|
| | 7 | 8 | 9 | 10 |
| Spiked amount | 0.1 | 0.2 | 0.4 | 1.0 |
| (wt %) | | | | |
| Spike and | —(*) | 112.5 | 118.8 | 95.0 |
| recovery | | | | |
| rate (%) | | | | |

(*)not calculated due to no peak detected

As listed in Table 3, it is found that the (HO-PEG)₂-O—CH₂—C₆H₅ contained in the (PEG)₂-O—CH₂—C₆H₅ in the formula (12) can be spiked and recovered in a range of 0.2 wt % or more, that is, it can be quantitated down to 0.2 wt %, with respect to the (PEG)₂-O—CH₂—C₆H₅.

### Example 4: Evaluation on Quantitating Property of 4Arm PEG-OH Contained in 4Arm PEG-CN

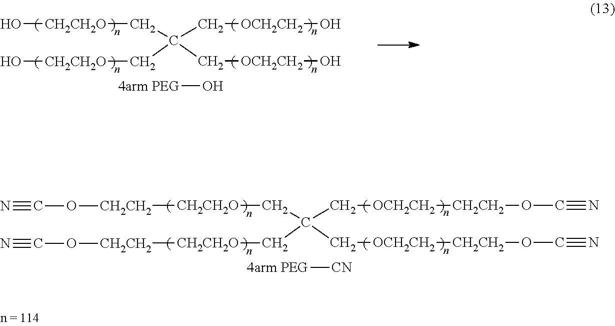

In a cyanoethylation reaction of obtaining 4arm PEG-CN from 4arm PEG-OH, as represented by the formula (13), the quantitating property of the unreacted 4arm PEG-OH was checked by a spike and recovery test in the following manner.

Into a screw tube into which 100 mg of “SUNBRIGHT PTE-200CN” (number average molecular weight: 20,086) manufactured by NOF Corporation having the same structure as the 4arm PEG-CN in the formula (13) was charged, “SUNBRIGHT PTE-20000” (number average molecular weight: 20,568) manufactured by NOF Corporation having the same structure as the “4arm PEG-OH” in the formula (13) was spiked at 0.1 wt % to 1.0 wt % with respect to “SUNBRIGHT PTE-200CN”, to obtain each sample in Experiment 11 to Experiment 14. To each sample, 80 μL of triphenylmethane (10 μg/μL) dissolved in deuterated chloroform and 620 μL of deuterated chloroform were added, followed by dissolution. Thereafter, 20 μL of trichloroacetyl isocyanate (TCI product) was added to each sample, followed by mixing by inversion. After the mixing by inversion, each sample was measured using a nuclear magnetic resonance apparatus by applying a pre-saturation method to a PEG chain-derived proton peak (3.56 ppm) and using inverse gated decoupling under the following conditions.
Reference peak: TMS
Quantitation reference peak: triphenylmethane ((C₆H₅)₃—CH, 5.55 ppm)
Target product peak: —[(OCH₂CH₂)ₙ—OCH₂CH₂—OCONH—COCCl₃]₄, 4.42 ppm
Pulse sequence: single_pulse_irrdec
Attenuator: 60 dB
Measurement temperature: 25° C.
Number of times for integration: 1024

When the integral value of the quantitation reference peak was set to 0.6548, a spike and recovery rate of each sample was calculated according to the following equation.

Spike and recovery rate (%)=(integral value of target product peak/8)×100

An allowable range of the spike and recovery rate was set as ±30%, and a range in which the spike and recovery was possible was checked.

TABLE 4

| | Experiment | Experiment | Experiment | Experiment |
|---|---|---|---|---|
| | 11 | 12 | 13 | 14 |
| Spiked amount | 0.1 | 0.2 | 0.4 | 1.0 |
| (wt %) | | | | |
| Spike and | —(*) | 46.3 | 75.6 | 106.3 |
| recovery | | | | |
| rate (%) | | | | |

(*)not calculated due to no peak detected

As listed in Table 4, it is found that the 4arm PEG-OH contained in the 4arm PEG-CN can be spiked and recovered in a range of 0.4 wt % or more, that is, it can be quantitated down to 0.4 wt %, with respect to the 4arm PEG-CN.

### Example 5: Evaluation on Quantitating Property of 8Arm PEG-OH Contained in 8Arm PEG-VS

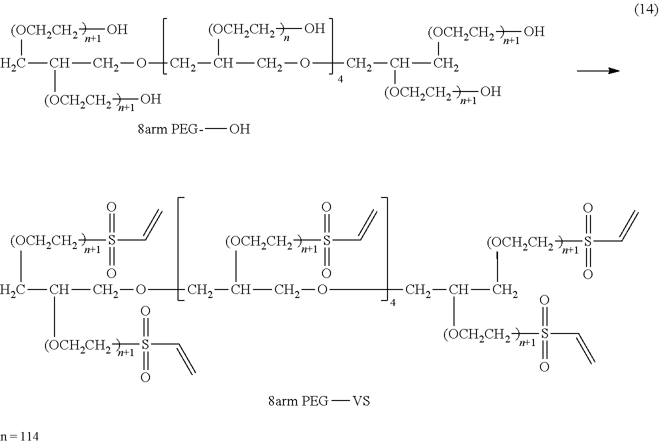

In a vinyl sulfonation reaction of obtaining 8arm PEG-VS from 8arm PEG-OH, as represented by the formula (14), the quantitating property of the unreacted 8arm PEG-OH was checked by a spike and recovery test in the following manner.

Into a screw tube into which 100 mg of “SUNBRIGHT HGEO-400VS” (number average molecular weight: 40,731) manufactured by NOF Corporation having the same structure as the 8arm PEG-VS in the formula (14) was charged, “SUNBRIGHT HGEO-40000” (number average molecular weight: 43,573) manufactured by NOF Corporation having the same structure as the 8arm PEG-OH in the formula (14) was spiked at 0.1 wt % to 1.0 wt % with respect to “SUNBRIGHT HGEO-400VS”, to obtain each sample in Experiment 15 to Experiment 18. To each sample, 80 μL of triphenylmethane (10 μg/μL) dissolved in deuterated chloroform and 620 μL of deuterated chloroform were added, followed by dissolution. Thereafter, 20 μL of trichloroacetyl isocyanate (TCI product) was added to each sample, followed by mixing by inversion. After the mixing by inversion, each sample was measured using a nuclear magnetic resonance apparatus by applying a pre-saturation method to a PEG chain-derived proton peak (3.56 ppm) and using inverse gated decoupling under the following conditions.
Reference peak: TMS
Quantitation reference peak: triphenylmethane ((C₆H₅)₃—CH, ppm)
Target product peak: —[(OCH₂CH₂)ₙ—OCH₂CH₂—OCONH—COCCl₃]₈, ppm
Pulse sequence: single_pulse_irrdec
Attenuator: 60 dB
Measurement temperature: 25° C.
Number of times for integration: 1024

When the integral value of the quantitation reference peak was set to 1.3096, a spike and recovery rate of each sample was calculated according to the following equation.

Spike and recovery rate (%)=(integral value of target product peak/16)×100

An allowable range of the spike and recovery rate was set as ±30%, and a range in which the spike and recovery was possible was checked.

TABLE 5

| | Experiment | Experiment | Experiment | Experiment |
|---|---|---|---|---|
| | 15 | 16 | 17 | 18 |
| Spiked amount | 0.1 | 0.2 | 0.4 | 1.0 |
| (wt %) | | | | |
| Spike and | —(*) | 111.5 | 95.8 | 110.3 |
| recovery | | | | |
| rate (%) | | | | |

(*)not calculated due to no peak detected

As listed in Table 5, it is found that the 8arm PEG-OH contained in the 8arm PEG-VS in the formula (14) can be spiked and recovered in a range of 0.2 wt % or more, that is, it can be quantitated down to 0.2 wt %, with respect to the 8arm PEG-VS.

### Comparative Example 1: Evaluation on Quantitating Property of (HO-PEG)₂-O—CH₂-C₆H₅ Contained in (PEG)₂-O—CH₂—C₆H₅

In the second stage of methoxylation process of obtaining the (PEG)₂-O—CH₂—C₆H₅ from the (Ms-PEG)₂-O—CH₂—C₆H₅ as shown in Example 3, the quantitating property of the unreacted (HO-PEG)₂-O—CH₂—C₆H₅ was checked by a spike and recovery test according to a method described in Patent Literature 1 in the following manner. The method described in Patent Literature 1 is a method using methanesulfonyl chloride as a labeling reagent.

Into a screw tube into which 100 mg of “SUNBRIGHT GL2-200BZ” (number average molecular weight: 19,451) manufactured by NOF Corporation as an equivalent product of the (PEG)₂-O—CH₂—C₆H₅ was charged, “SUNBRIGHT 2 MS-GL2-200BZ” (number average molecular weight: 19,607) manufactured by NOF Corporation as an equivalent product of the (Ms-PEG)₂-O—CH₂—C₆H₅, obtained by labeling the (HO-PEG)₂-O—CH₂—C₆H₅ with methanesulfonyl chloride, was spiked at 0.1 wt % to 2.0 wt % with respect to “SUNBRIGHT GL2-200BZ”, to obtain each sample in Experiment 19 to Experiment 22. To each sample, 700 μL of deuterated chloroform was added, followed by dissolution, and then each sample was measured using a nuclear magnetic resonance apparatus under the following conditions.

No pre-saturation method or inverse gated decoupling was applied.
Reference peak: TMS
Quantitation reference peak: —CH₂—O—CH₂—C₆H₅, 4.54 ppm
Target product peak: —((OCH₂CH₂)ₙ—O—S(═O)₂—CH₃)₂, 3.00 ppm
Pulse sequence: single_pulse
Measurement temperature: 25° C.
Number of times for integration: 128

When the integral value of the quantitation reference peak was set to 2.000, a spike and recovery rate of each sample was calculated according to the following equation.

Spike and recovery rate (%)=(integral value of target product peak/6)×100

An allowable range of the spike and recovery rate was set as ±30%, and a range in which the spike and recovery was possible was checked.

TABLE 6

| | Experiment | Experiment | Experiment | Experiment |
|---|---|---|---|---|
| | 19 | 20 | 21 | 22 |
| Spiked amount | 0.1 | 0.2 | 0.4 | 1.0 |
| (wt %) | | | | |
| Spike and | —(*) | 91.9 | 75.3 | 102.7 |
| recovery | | | | |
| rate (%) | | | | |

(*)not calculated due to no peak detected

As listed in Table 6, it is found that the (HO-PEG)₂-O—CH₂—C₆H₅ contained in the (PEG)₂-O—CH₂—C₆H₅ can be quantitated down to 0.2 wt % with respect to the (PEG)₂-O—CH₂—C₆H₅. That is, the unreacted (HO-PEG)₂-O—CH₂—C₆H₅ contained in the (PEG)₂-O—CH₂—C₆H₅ can be spiked and recovered in a range of 0.2 wt % or more, that is, it can be quantitated down to 0.2 wt %. This is equivalent to the quantitating property shown in Example 3, indicating that the analysis method according to the present invention has quantitative accuracy equivalent to that previously reported.

### Example 6: Evaluation on Production Time in Present Invention

During one-pot synthesis as a two-stage reaction of obtaining (PEG)₂-O—CH₂—C₆H₅ from (HO-PEG)₂-O—CH₂—C₆H₅, as described Patent Literature 1, the production time required when the analysis method according to the present invention was used to check the completion of the reaction process was evaluated in the following manner.

That is, according to Example 16-4 in Patent Literature 1, the second alkyl etherification was carried out over 9 hours using (HO-PEG)₂-O—CH₂—C₆H₅ (200 g) as a raw material, and then the completion of the reaction process was checked using the analysis method according to the present invention, that is, in the following manner.

The reaction solution (5 mL) was sampled, and the precipitate was removed by suction filtration. To the obtained filtrate, 100 mL of ethyl acetate was added, and the mixture was stirred for 5 minutes under a nitrogen atmosphere. Thereafter, 100 mL of hexane was added, the mixture was stirred for 10 minutes to precipitate crystals, and then the crystals were collected by suction filtration.

The collected crystals were dried under a reduced pressure for 1 hour, and 100 mg of the dry solid was dissolved in 0.7 mL of deuterated chloroform. 20 μL of trichloroacetyl isocyanate was spiked thereto, followed by mixing by inversion. Thereafter, the amount of the unreacted (HO-PEG)₂-O—CH₂—C₆H₅ was checked by ¹H-NMR analysis under the same measurement conditions as in Example 3, and it was found that the reaction was complete.

It was found by the analysis over 3 hours after sampling the reaction solution that the amount of the unreacted (HO-PEG)₂-O—CH₂—C₆H₅ was 0.2% or less. Then, according to Example 16-4 in Patent Literature 1, washing with water, dehydration, and crystallization were carried out for 6 hours, followed by drying under a reduced pressure for 8 hours, and the (PEG)₂-O—CH₂—C₆H₅ was obtained in a total production time of 26 hours.

### Comparative Example 2: Evaluation on Production Time in Related-Art Method

During one-pot synthesis as a two-stage reaction of obtaining the (PEG)₂-O—CH₂—C₆H₅ from the (HO-PEG)₂-O—CH₂—C₆H₅, as described Patent Literature 1, in order to check the completion of the reaction process, methanesulfonyl chloride was used as a labeling reagent, and in the case of no reaction, the production time to check the amount of the (HO-PEG)₂-O—CH₂—C₆H₅ was evaluated in the following manner.

According to Example 16-4 in Patent Literature 1, the second alkyl etherification was carried out over 9 hours using (HO-PEG)₂-O—CH₂—C₆H₅ (200 g) as a raw material, and then the completion of the reaction process was checked using the method described in Example 27 in Patent Literature 1, that is, in the following manner.

The reaction solution (20 mL) was sampled, and the precipitated chloride was removed by suction filtration. To the obtained filtrate, 300 mL of ethyl acetate was added, and the mixture was stirred for 5 minutes under a nitrogen atmosphere. Thereafter, 300 mL of hexane was added, the mixture was stirred for 30 minutes to precipitate crystals, and then the crystals were collected by suction filtration.

The collected crystals were dried under a reduced pressure for 5 hours, 3.0 g of the obtained dry solid was charged into a round bottom flask, and 100 g of toluene was added thereto and heated under a reflux for 1 hour to azeotropically remove 50 g of toluene and water. After cooling to room temperature, 0.095 g of triethylamine was added, the mixture was heated to 40° C., 0.054 g of methanesulfonyl chloride was spiked, and the mixture was reacted at 40° C. for 3 hours. After the reaction was completed, the precipitated chloride was removed by suction filtration. To the obtained filtrate, 100 mL of ethyl acetate was added, and the mixture was stirred for 5 minutes under a nitrogen atmosphere. Thereafter, 100 mL of hexane was added, the mixture was stirred for 10 minutes to precipitate crystals, and then the crystals were collected by suction filtration.

The collected crystals were dried under a reduced pressure for 6 hours, and 20 mg of the obtained crystals were dissolved in 0.7 mL of deuterated chloroform. The amount of the unreacted (HO-PEG)₂-O—CH₂—C₆H₅ was checked by ¹H-NMR analysis under the same measurement conditions as in Comparative Example 1, and it was found that the reaction was complete.

It was found by the analysis over 17 hours after sampling the reaction solution that the amount of the unreacted (HO-PEG)₂-O—CH₂—C₆H₅ was 0.2% or less. Then, according to Example 16-4 in Patent Literature 1, washing with water, dehydration, and crystallization were carried out for 6 hours, followed by drying under a reduced pressure for 8 hours, and the (PEG)₂-O—CH₂—C₆H₅ was obtained in a total production time of 40 hours.

That is, compared to Example 6, the production time was 14 hours longer.

From the above, it is indicated that the present invention can sufficiently shorten the production time compared to the related-art method.

### INDUSTRIAL APPLICABILITY

According to the present invention, in the production of obtaining a high molecular weight polyoxyethylene derivative by derivatizing a hydroxy group using a high molecular weight polyoxyethylene compound having a hydroxy group as a raw material, the time required for process analysis can be shortened and the total production time can be shortened.

Although the present invention has been described in detail and with reference to specific embodiments, it will be apparent to those skilled in the art that various changes and modifications can be made without departing from the spirit and scope of the present invention.

The present application is based on a Japanese patent application (Japanese Patent Application No. 2022-35886) filed on Mar. 9, 2022, the contents which are incorporated herein by reference.

1. A method for producing a high molecular weight polyoxyethylene derivative having a derivatized hydroxy group by derivatizing a hydroxy group in a high molecular weight polyoxyethylene compound having the hydroxy group, the method comprising:
labeling the high molecular weight polyoxyethylene compound having the hydroxy group, which is unreacted, using a labeling reagent in a deuterated solvent; and
quantitating a labeled solution by a pre-saturation method and a proton nuclear magnetic resonance spectroscopy using inverse gated decoupling.

2. The method for producing a high molecular weight polyoxyethylene derivative having a derivatized hydroxy group according to claim 1, wherein the high molecular weight polyoxyethylene compound having the hydroxy group is represented by the following formula (1): 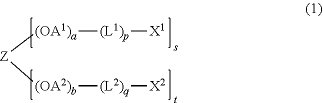
wherein, in the formula (1),
OA¹ and OA² are an oxyethylene group,
a and b are each independently 0 to 2,500, and a+b is 200 or more,
L¹ and L² are each independently an alkylene group which may have a bond selected from an ester bond, a urethane bond, an amide bond, a urea bond, an ether bond, and a thioether bond in an alkylene chain or at an end thereof, and the alkylene groups may be same as or different from each other in one molecule,
p and q are each independently 0 or 1,
s and t are each independently 0 to 8, and 2≤s+t≤8,
X¹ is a hydroxy group, an alkoxy group, an azide group, an oxycarbonyl group, an oxycarbonyloxy group, an oxycarbamoyl group, a cyano group, a silyl group, an acyloxy group, a sulfonyl group, or an imido group, and when t is 0, X¹ is a hydroxy group,
X² is a hydroxy group, and
Z is a residue obtained by removing all hydroxy groups from a compound having 2 to 8 hydroxy groups and 2 to 21 carbon atoms.

3. The method for producing a high molecular weight polyoxyethylene derivative having a derivatized hydroxy group according to claim 1, wherein the high molecular weight polyoxyethylene derivative having a derivatized hydroxy group is represented by the following formula (2): 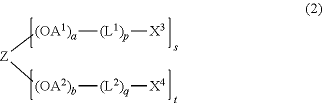
wherein, in the formula (2),
OA¹ and OA² are an oxyethylene group,
a and b are each independently 0 to 2,500, and a+b is 200 or more,
L¹ and L² are each independently an alkylene group which may have a bond selected from an ester bond, a urethane bond, an amide bond, a urea bond, an ether bond, and a thioether bond in an alkylene chain or at an end thereof, and the alkylene groups may be same as or different from each other in one molecule,
p and q are each independently 0 or 1,
s and t are each independently 0 to 8, and 2≤s+t≤8,
X³ and X⁴ are each independently an alkoxy group, an azide group, an oxycarbonyl group, an oxycarbonyloxy group, an oxycarbamoyl group, a cyano group, a silyl group, an acyloxy group, a sulfonyl group, or an imido group, and
Z is a residue obtained by removing all hydroxy groups from a compound having 2 to 8 hydroxy groups and 2 to 21 carbon atoms.

4. The method for producing a high molecular weight polyoxyethylene derivative having a derivatized hydroxy group according to claim 1, wherein the labeling reagent is an isocyanate reagent represented by the following formula (3): 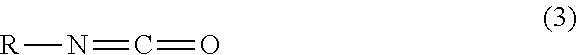
wherein, in the formula (3), R represents an organic group having an electron-withdrawing group.

5. A labeling reagent for analysis use for a high molecular weight polyoxyethylene compound having a hydroxy group, which is represented by a formula (3): 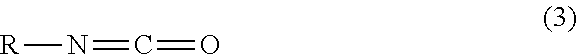
wherein, in the formula (3), R represents an organic group having an electron-withdrawing group.

6. A method for quantitating a high molecular weight polyoxyethylene compound having a hydroxy group contained in a high molecular weight polyoxyethylene derivative, the method comprising:
labeling the high molecular weight polyoxyethylene compound having a hydroxy group using a labeling reagent in a deuterated solvent; and
quantitating a labeled solution by a pre-saturation method and a proton nuclear magnetic resonance spectroscopy using inverse gated decoupling.

7. The method for producing a high molecular weight polyoxyethylene derivative having a derivatized hydroxy group according to claim 2, wherein the high molecular weight polyoxyethylene derivative having a derivatized hydroxy group is represented by the following formula (2): 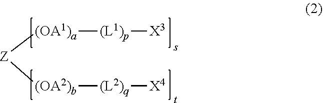
wherein, in the formula (2),
OA¹ and OA² are an oxyethylene group,
a and b are each independently 0 to 2,500, and a+b is 200 or more,
L¹ and L² are each independently an alkylene group which may have a bond selected from an ester bond, a urethane bond, an amide bond, a urea bond, an ether bond, and a thioether bond in an alkylene chain or at an end thereof, and the alkylene groups may be same as or different from each other in one molecule,
p and q are each independently 0 or 1,
s and t are each independently 0 to 8, and 2≤s+t≤8,
X³ and X⁴ are each independently an alkoxy group, an azide group, an oxycarbonyl group, an oxycarbonyloxy group, an oxycarbamoyl group, a cyano group, a silyl group, an acyloxy group, a sulfonyl group, or an imido group, and
Z is a residue obtained by removing all hydroxy groups from a compound having 2 to 8 hydroxy groups and 2 to 21 carbon atoms.

8. The method for producing a high molecular weight polyoxyethylene derivative having a derivatized hydroxy group according to claim 2, wherein the labeling reagent is an isocyanate reagent represented by the following formula (3): 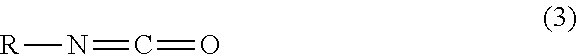
wherein, in the formula (3), R represents an organic group having an electron-withdrawing group.

9. The method for producing a high molecular weight polyoxyethylene derivative having a derivatized hydroxy group according to claim 3, wherein the labeling reagent is an isocyanate reagent represented by the following formula (3): 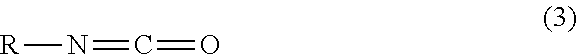
wherein, in the formula (3), R represents an organic group having an electron-withdrawing group.

10. The method for producing a high molecular weight polyoxyethylene derivative having a derivatized hydroxy group according to claim 7, wherein the labeling reagent is an isocyanate reagent represented by the following formula (3): 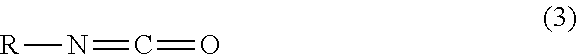
wherein, in the formula (3), R represents an organic group having an electron-withdrawing group.
